(19) United States
(12) Patent Application Publication
(10) Pub. No.: US 2013/0179351 A1
(43) Pub. Date: Jul. 11, 2013

(54) SYSTEM AND METHOD FOR AN AUTHENTICATING AND ENCRYPTING CARD READER

(71) Applicant: GEORGE WALLNER, MIAMI BEACH, FL (US)

(72) Inventor: GEORGE WALLNER, MIAMI BEACH, FL (US)

(21) Appl. No.: 13/345,898

(22) Filed: Jan. 9, 2012

(51) Int. Cl. G06Q 20/20; G06Q 20/34

(52) U.S. Cl. 705/71

(57) ABSTRACT

A system for encrypting and authenticating a payment transaction includes a card reader, a computing device, a card swipe application and a checkout application. The card reader includes a reader head, a secure microcontroller, and an interface. The reader head reads payment card data from a payment card. The secure microcontroller stores a unique reader identification (reader ID), and at least a first encryption key, and includes a payment card decoder application and an encryption application. The encryption application encrypts the payment card data and produces encrypted payment card data. The encryption application further encrypts the transaction data with the first encryption key and produces encrypted transaction data. The checkout application receives the encrypted payment card data and the encrypted transaction data and forwards them to a payment server for processing of the payment transaction.

### FIELD OF THE INVENTION

The present invention relates to a system and a method for an authenticating and encrypting card reader and in particular to a card reader that encrypts the payment card data and authenticates the transaction data.

### BACKGROUND OF THE INVENTION

Visa and MasterCard electronic card payment transactions originating at the point of sale or through e-commerce attract a Merchant Discount. The Merchant Discount, which is a small percentage of the transaction amount, is charged to the merchant by the Acquirer (the merchant's bank). The Acquirer sends the transactions to the Card-Issuer (the card holders' bank) via Visa and MasterCard. Part of the Merchant Discount is paid to the Card Issuer by the Acquirer via Visa and MasterCard. This portion of the Merchant Discount is called the Interchange. The Interchange, which is set by Visa and MasterCard, is normally the largest component of the Merchant Discount.

The amount of Interchange charged on a transaction depends on many factors. These include the type of transaction (credit or debit), the type and size of the merchant and on how the card data is entered. When a card's magnetic stripe (or internal chip) is used to read the card data, the transaction attracts a lower Interchange than when the card data is entered manually (called key-entry). Interchange for card swipe credit card transactions ranges from 0.95 to 1.8 percent. Interchange on key-entry e-commerce transactions is between 1.9 and 2.5 percent.

Currently most point of sale transactions are originated by reading the magnetic stripe (called “card swipe”). Internet e-commerce transactions, on the other hand, are all key-entry transactions, with the consumer entering his card's number via the keyboard of his computer.

As card numbers are difficult to keep secret—i.e. they need to be entered, transmitted, processed and stored in order to use them in transactions—fraud tends to be higher on key-entry transactions. The magnetic stripe, while not inherently secure, is much harder to copy and provides a much higher level of security. The higher Interchange on key-entry transactions represents the additional risk in this type of transactions, and in turn increases e-commerce merchants' costs.

The conversion of key-entry e-commerce transaction into lower Interchange card read transactions carries a potential risk for the card issuers. Should such readers become widely used, and should such readers and systems become compromised, the resulting fraud losses could extend outside Internet. While key-entry exposes card numbers to theft, the data obtained from such theft is not sufficient to create counterfeit magnetic stripe cards. Card readers, that read the entire magnetic stripe, on the other hand could create the potential to expose the data necessary for counterfeiting magnetic stripe cards. It is therefore important that a widely distributed card reader be able to cut existing fraud and not become the source of new fraud. This places a number of requirements on an e-commerce card reader, which to date have not been met by the prior art attempts.

Accordingly, it is desirable to replace payment card data key entry with a card swipe, in order to securely convert key entry e-commerce transactions into cryptographically authenticated card present transactions eligible for a lower Interchange. It is also desirable to provide a card reader that is fraud resistant.

### SUMMARY OF THE INVENTION

The present invention describes a card reader that authenticates both the payment card data and the transaction data.

In general, one aspect of the invention provides a system for encrypting and authenticating a payment transaction. The system includes a card reader, a computing device, a card swipe application and a checkout application. The card reader includes a reader head, a secure microcontroller, and an interface. The reader head is configured to read payment card data from a payment card. The secure microcontroller stores a unique reader identification (reader ID), and at least a first encryption key, and includes a payment card decoder application and an encryption application. The encryption application encrypts the payment card data and produces encrypted payment card data. The computing device is configured to connect to the card reader via the interface and to a payment server via an Internet connection. The card swipe application is configured to run on the computing device and to detect the presence of the card reader and upon confirmation of the presence of the card reader to transmit transaction data to the card reader. The transaction data include transaction amount, transaction date and transaction time, and the encryption application further encrypts the transaction data with the first encryption key and produces encrypted transaction data. The checkout application is configured to facilitate the checkout process with an e-commerce retailer. The checkout application receives the encrypted payment card data and the encrypted transaction data and forwards them to a payment server for processing of the payment transaction.

Implementations of this aspect of the invention include the following. The encryption application generates a transaction authentication block (TAB) for the encrypted transaction data. The TAB is generated by hashing and encrypting the reader ID, the payment card's primary account number (PAN), the transaction amount, the transaction date, the transaction time and an internally generated transaction sequence number (TSN). The card reader transmits the encrypted payment card data, the reader ID, the TSN and the TAB to the checkout application. The interface may be a universal serial bus (USB) interface. The interface may be an audio interface, and in that case, the card reader connects to the computing device via a microphone port or headphone port. The payment card may be a magnetic stripe for storing the payment card data and the reader head may be a magnetic head. The payment card may be a contact-type smart card and the contact-type smart card may include an electronic circuit for storing the payment card data and the reader head may be an electrical contact circuit head. The payment card may be a contactless smart card and the contactless smart card includes an electronic circuit for storing the payment card data and the reader head may be a contactless near-field electromagnetic circuit head. The card swipe application prompts a user to swipe the payment card in the card reader and the card reader checks for an error in the payment card data and verifies absence of an error in the payment card data. The encryption application encrypts the payment card data with a second encryption key. The second encryption key may be derived from the first encryption key. The system may further include a plurality of card readers and the payment server includes a database that stores all of the card readers IDs and their corresponding encryption keys and the payment server uses the reader ID of a card reader to find the corresponding encryption keys and uses the encryption keys to decrypt the encrypted payment card data and to generate a local payment server TAB. The payment server authenticates the transaction data by comparing the TAB forwarded by the checkout application with the generated local payment server TAB. The computing device may be a personal computer, a laptop, a mobile communication device, a tablet computer, a point-of-sale device, or a computing circuit.

In general, in another aspect, the invention provides a method for encrypting and authenticating a payment transaction including providing a card reader, providing a computing device, providing a card swipe application and a checkout application. The card reader includes a reader head, a secure microcontroller, and an interface. The reader head reads payment card data from a payment card. The secure microcontroller stores a unique reader identification (reader ID), and at least a first encryption key, and includes a payment card decoder application and an encryption application. The encryption application encrypts the payment card data and produces encrypted payment card data. The computing device connects to the card reader via the interface and to a payment server via an Internet connection. The card swipe application runs on the computing device and detects the presence of the card reader and upon confirmation of the presence of the card reader transmits transaction data to the card reader. The transaction data include transaction amount, transaction date and transaction time, and the encryption application further encrypts the transaction data with the first encryption key and produces encrypted transaction data. The checkout application facilitates the checkout process with an e-commerce retailer. The checkout application receives the encrypted payment card data and the encrypted transaction data and forwards them to a payment server for processing of the payment transaction.

Among the advantages of this invention may be one or more of the following. The card reader of the present invention has tamper resistant construction and provides card data encryption and transaction authentication. Card data encryption protects against card data theft. Tamper resistance ensures that encryption keys cannot be retrieved from a reader, and used to decrypt card data. Transaction authentication prevents a number of possible fraud scenarios that encryption on its own cannot prevent. These include card substitution, transaction replay and transaction amount tampering. In summary, the present invention provides a low cost, secure card reader and associated software that allows e-commerce transactions to become authenticated card swipe transactions, eligible for a lower Interchange.

### BRIEF DESCRIPTION OF THE DRAWINGS

Referring to the figures, wherein like numerals represent like parts throughout the several views:

FIG. 1 is an overview diagram of the payment card reader authentication system, according to this invention;

FIG. 2 is a schematic diagram of the authenticated card reader of this invention; and

FIG. 3A and FIG. 3B depict a flow diagram of the authenticated card reading process, according to this invention.

### DETAILED DESCRIPTION OF THE INVENTION

The present invention provides a low cost, secure card reader and associated software that allows e-commerce key-entry transactions to become authenticated card swipe transactions, eligible for a lower Interchange. The card reader of the present invention encrypts and authenticates both the payment card data and the transaction data and turns e-commerce transactions into cryptographically authenticated card-swipe, card present transactions.

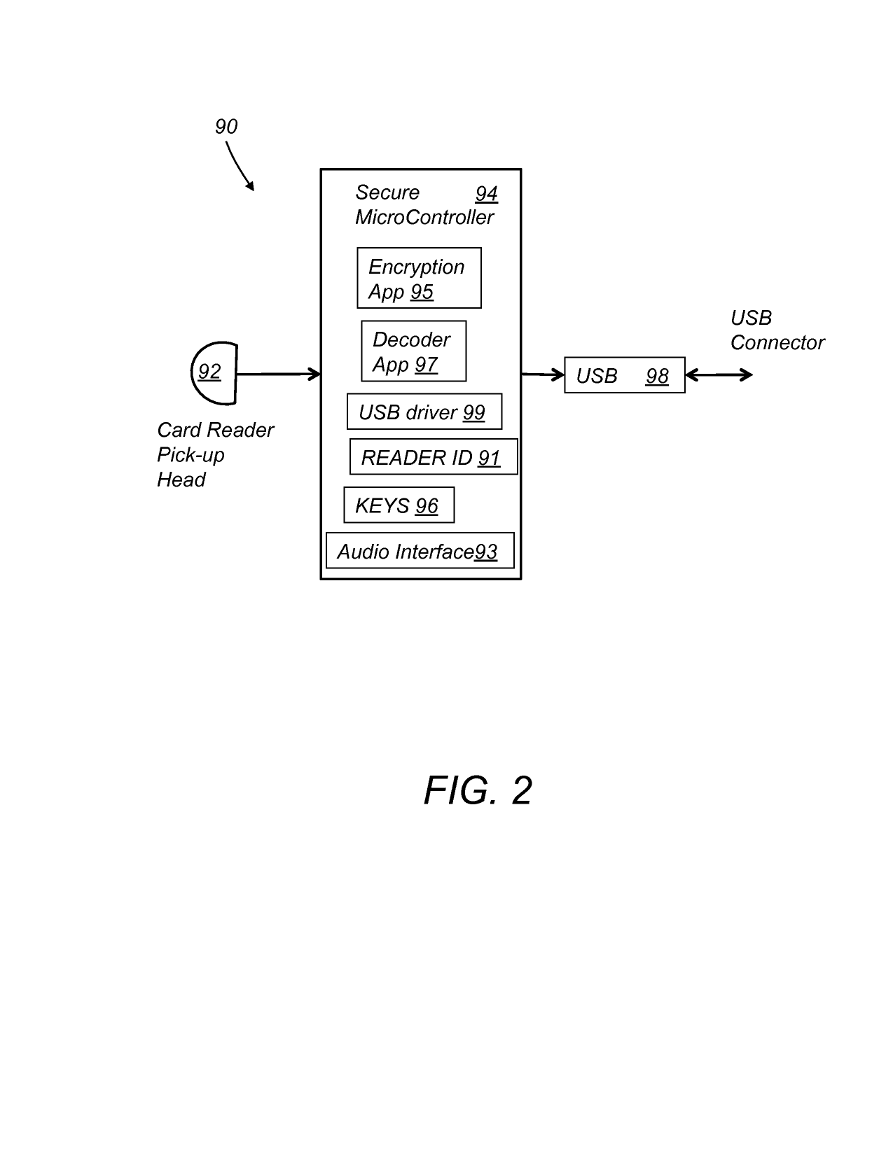

Referring to FIG. 2, card reader 90 (WebSwipe) includes a magnetic stripe reader head 92, a secure microcontroller 94 and a USB interface 98. Microcontroller 94 contains a card decoder application 97, various encryption algorithms 95 and various USB communications interface drivers 99. Microcontroller 94 also stores a unique Reader ID 91 and associated encryption keys 96.

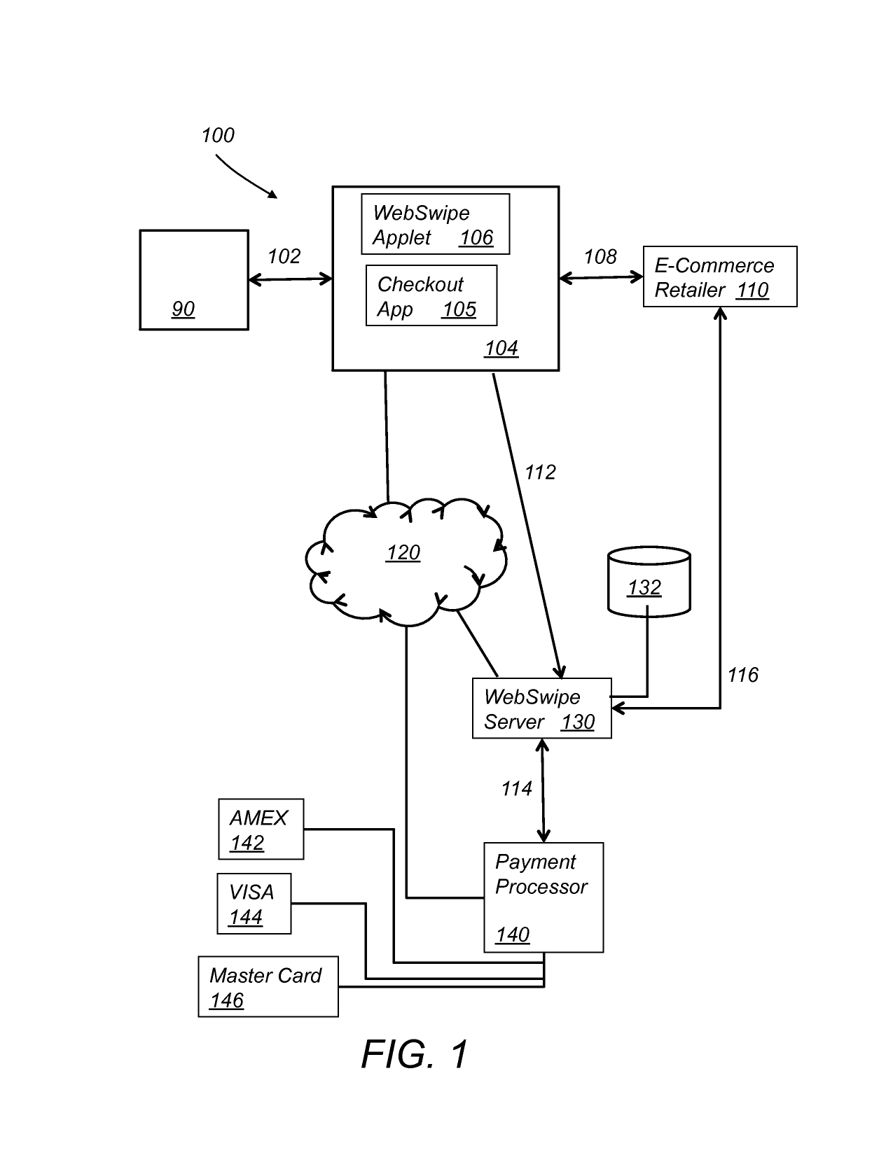

Referring to FIG. 1, WebSwipe reader 90 communicates with a personal computer (PC) 104 through the USB interface 98. PC 104 is connected directly or via the Internet 120 with an Internet based server (WebSwipe server) 130 and thereby the reader 90 communicates via the PC with the Internet based server 130. In an alternative implementation, the reader 90 is also equipped with an audio interface 93, and the reader audio interface 93 is plugged into the PC's headphone and microphone jacks and this allows the reader 90 to communicate with the PC 104 and the server 130 via encoded audio tones. PC 104 also includes a card swipe application 105 and a checkout application 105 that facilitates the checkout process 108 with the e-commerce retailer 110. Alternatively, the checkout and card swipe applications may reside on a server and are accessed via the Internet using a browser installed in the PC.

During checkout 108 in an e-commerce transaction with e-commerce retailer 110, the manual entry steps of the card number, expiry date and CVV get replaced by a simple card swipe. This information derived from the card's magnetic stripe (i.e., card number, expiry date and CVV) is transmitted to the WebSwipe Server 130 via the Internet connection 120, and from there to a payment processor 140. The payment server 130 also has a database 132 that stores all WebSwipe Reader IDs 91 and their corresponding keys 96

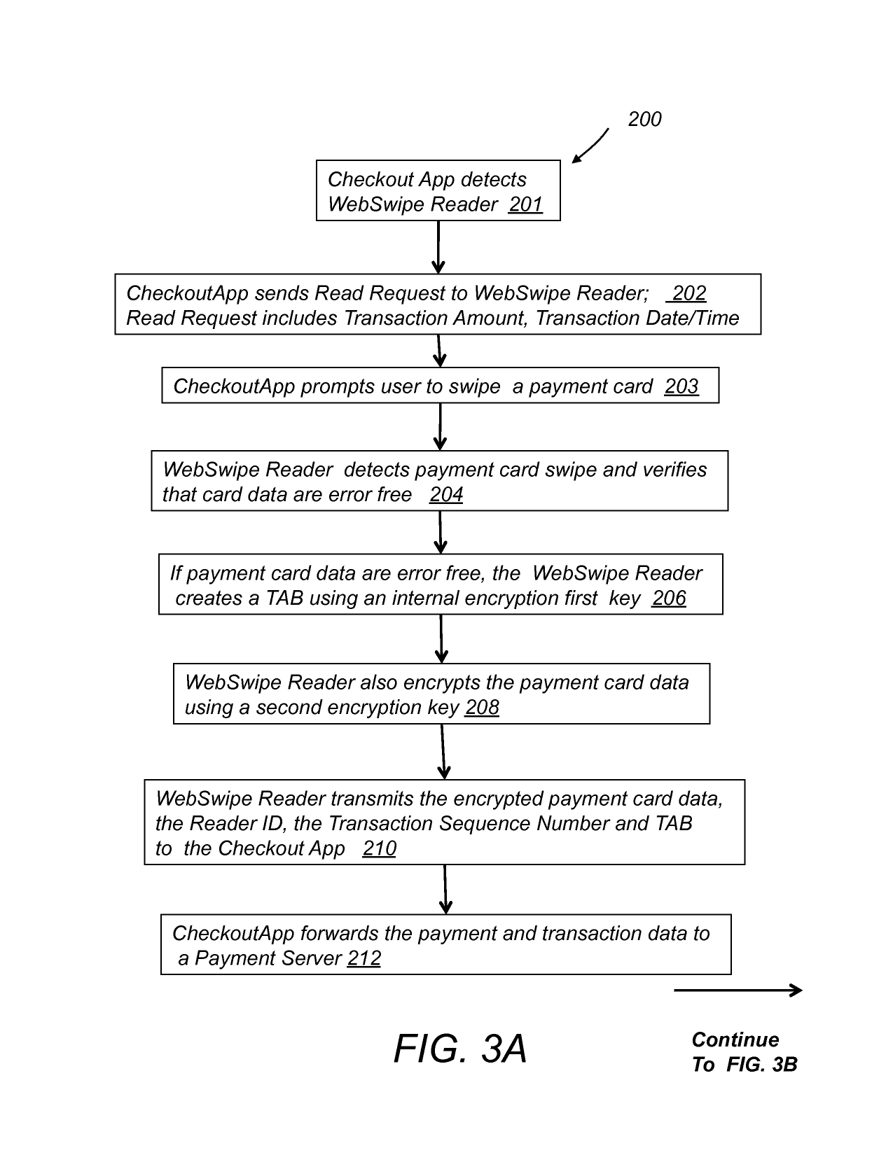

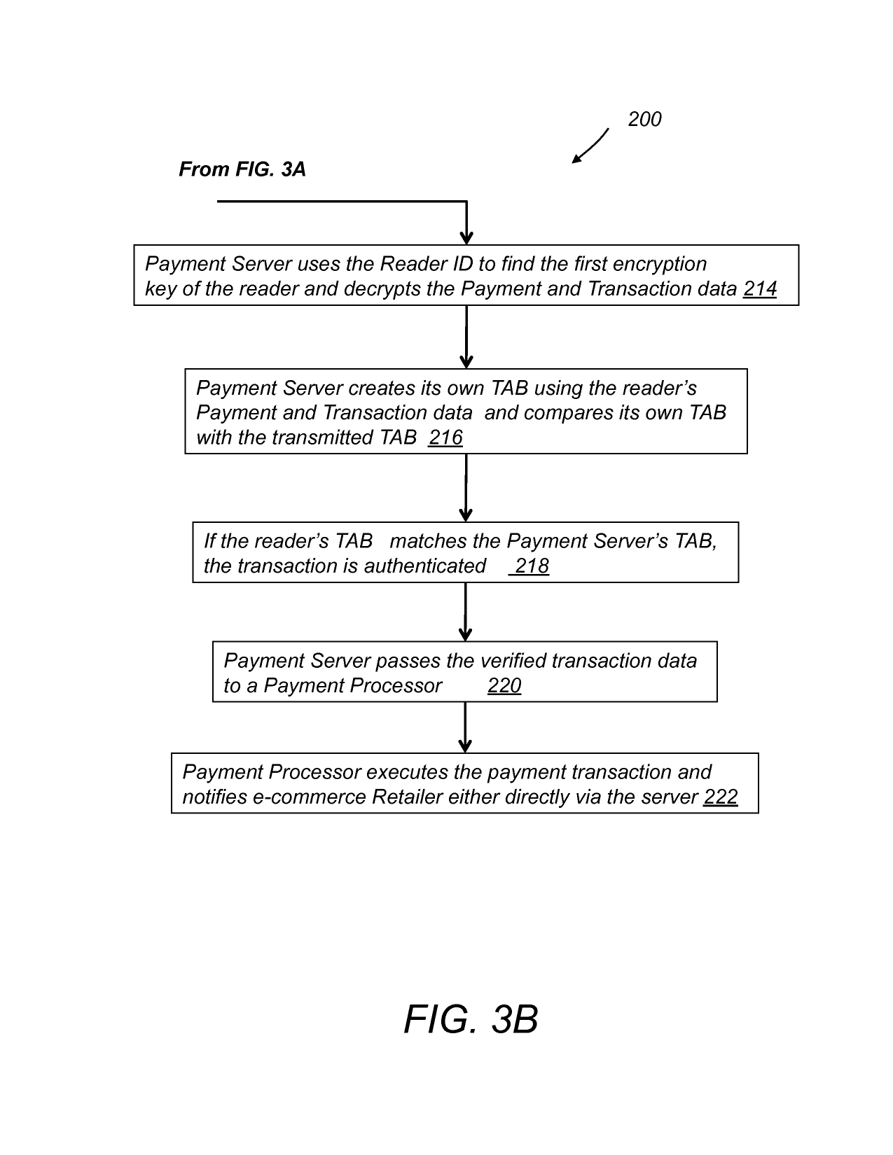

Referring to FIGS. 3A and 3B, during a checkout transaction process 200 WebSwipe performs the following steps:

First, the card swipe application 106 (WebSwipe App) that runs on the PC 104 detects that a WebSwipe Reader 90 is plugged-in (201). If the reader 90 is not detected, the user is prompted to proceed with key-entry. When the application 106 recognizes the WebSwipe Reader 90, it transmits to the reader a “Read Request”, which includes the transaction amount and the transaction date and time (202). The application 106 then prompts the user to swipe his card (203). When the reader 90 detects the card swipe, it verifies that the card data are error free (204). If the data are good, the reader 90 performs the following steps: Using an internally stored first key 96, it creates a Transaction Authentication Block (TAB), which is a cryptographic checksum created by hashing and encrypting the Reader ID, the card's Primary Account Number (PAN), the transaction amount, transaction date and time, and an internally generated Transaction Sequence Number (TSN) (206). Next, reader 90, using a second key 96, also encrypts the card's magnetic stripe data (208), and then transmits the encrypted payment card data, the Reader ID, the TSN and the TAB to the checkout application 105 (210), which then forwards it to the payment server 130 (212). The second encryption key may be a separate key or may be derived from the first key.

Payment server 130 uses the Reader ID 91 to find the first and second keys 96 belonging to the reader 90 (214), and using those keys 96, decrypts the card data and creates its own TAB using the same data the WebSwipe reader used (i.e. PAN, CVV, PVV, the transaction amount, transaction date and time, TSN) (216). Next, payment server 130 compares its locally generated TAB with the TAB received in the transaction in order to authenticate the transaction details (218). The payment server 130 does not decrypt the TAB, but it generates its own TAB and compares it with the TAB received in the transaction. Matching TAB-s indicate a transaction that has not been altered. This verification of the TAB precludes the fraudulent alteration of the transaction details, or the replay of a transaction. The encryption of the magnetic stripe contents precludes the theft of card data. Next, payment server 130 passes the verified transaction data (including the decrypted magstripe data) to the payment processor 10 in a standard data format, such as IS8583 (220). Finally, the payment processor executes the payment transaction and notifies the e-commerce retailer 110 (222).

The payment server 130 may be implemented in either software or hardware form, or a combination of software and hardware. Additional data entry steps may be added to increase transaction security. These may include the entry of cardholder's zip code, address, phone number and e-mail address for on-line verification.

Other embodiments may include one or more of the following. The payment card may be a contact-type smart card and the contact-type smart card may include an electronic circuit for storing the payment card data and the reader head may be an electrical contact circuit head. The payment card may be a contactless smart card and the contactless smart card includes an electronic circuit for storing the payment card data and the reader head may be a contactless near-field electromagnetic circuit head. Personal computer 104 may be substituted by a laptop, a mobile communication device, a tablet computer, a point-of-sale device, or a computing circuit.

Several embodiments of the present invention have been described. Nevertheless, it will be understood that various modifications may be made without departing from the spirit and scope of the invention. Accordingly, other embodiments are within the scope of the following claims.

What is claimed is:

1. A system for encrypting and authenticating a payment transaction comprising:
a card reader comprising a reader head, a secure microcontroller, and an interface, wherein said reader head is configured to read payment card data from a payment card, and wherein said secure microcontroller stores a unique reader identification (reader ID), and at least a first encryption key, and comprises a payment card decoder application and an encryption application, and wherein said encryption application encrypts the payment card data and produces encrypted payment card data;
a computing device configured to connect to said card reader via said interface and to a payment server via an Internet connection;
a card swipe application configured to run on said computing device and to detect the presence of said card reader and upon confirmation of the presence of the card reader to transmit transaction data to said card reader, wherein said transaction data comprise transaction amount, transaction date and transaction time, and wherein said encryption application further encrypts said transaction data with said first encryption key and produces encrypted transaction data; and
a checkout application configured to facilitate the checkout process with an e-commerce retailer, wherein said checkout application receives the encrypted payment card data and the encrypted transaction data and forwards them to a payment server for processing of the payment transaction.

2. The system of claim 1 wherein said encryption application generates a transaction authentication block (TAB) for said encrypted transaction data and wherein said TAB is generated by hashing and encrypting the reader ID, the payment card's primary account number (PAN), the transaction amount, the transaction date, the transaction time and an internally generated transaction sequence number (TSN).

3. The system of claim 2 wherein said card reader transmits the encrypted payment card data, the reader ID, the TSN and the TAB to the checkout application.

4. The system of claim 1 wherein said interface comprises a universal serial bus (USB) interface.

5. The system of claim 1 wherein said interface comprises an audio interface and wherein said card reader connects to said computing device via a microphone port or headphone port.

6. The system of claim 1 wherein said payment card comprises a magnetic stripe for storing said payment card data and wherein said reader head comprises a magnetic head.

7. The system of claim 1 wherein said payment card comprises a contact-type smart card and said contact-type smart card comprises an electronic circuit for storing said payment card data and wherein said reader head comprises an electrical contact circuit head.

8. The system of claim 1 wherein said payment card comprises a contactless smart card and said contactless smart card comprises an electronic circuit for storing said payment card data and wherein said reader head comprises a contactless near-field electromagnetic circuit head.

9. The system of claim 1 wherein said card swipe application prompts a user to swipe the payment card in said card reader and wherein the card reader checks for an error in said payment card data and verifies absence of an error in said payment card data.

10. The system of claim 2, wherein said encryption application encrypts said payment card data with a second encryption key.

11. The system of claim 10 wherein said second encryption key is derived from the first encryption key.

12. The system of claim 1 wherein said system further comprises a plurality of card readers and wherein said payment server comprises a database that stores all of said card readers IDs and their corresponding encryption keys and wherein the payment server uses the reader ID of a card reader to find the corresponding encryption keys and uses the encryption keys to decrypt the encrypted payment card data and to generate a local payment server TAB.

13. The system of claim 12 wherein said payment server is configured to authenticate the transaction data by comparing the TAB forwarded by the checkout application with the generated local payment server TAB.

14. The system of claim 1, wherein said computing device comprises one of a personal computer, a laptop, a mobile communication device, a tablet computer, a point-of-sale device, or a computing circuit.

15. A method for encrypting and authenticating a payment transaction comprising:
providing a card reader comprising a reader head, a secure microcontroller, and an interface, wherein said reader head is configured to read payment card data from a payment card, and wherein said secure microcontroller stores a unique reader identification (reader ID), and at least a first encryption key, and comprises a payment card decoder application and an encryption application, and wherein said encryption application encrypts the payment card data and produces encrypted payment card data;
providing a computing device configured to connect to said card reader via said interface and to a payment server via an Internet connection;
providing a card swipe application configured to run on said computing device and to detect the presence of said card reader and upon confirmation of the presence of the card reader to transmit transaction data to said card reader, wherein said transaction data comprise transaction amount, transaction date and transaction time, and wherein said encryption application further encrypts said transaction data with said first encryption key and produces encrypted transaction data; and
providing a checkout application configured to facilitate the checkout process with an e-commerce retailer, wherein said checkout application receives the encrypted payment card data and the encrypted transaction data and forwards them to a payment server for processing of the payment transaction.

16. The method of claim 15 wherein said encryption application generates a transaction authentication block (TAB) for said encrypted transaction data and wherein said TAB is generated by hashing and encrypting the reader ID, the payment card's primary account number (PAN), the transaction amount, the transaction date, the transaction time and an internally generated transaction sequence number (TSN).

17. The method of claim 16 wherein said card reader transmits the encrypted payment card data, the reader ID, the TSN and the TAB to the checkout application.

18. The method of claim 15 wherein said interface comprises a universal serial bus (USB) interface.

19. The method of claim 15 wherein said interface comprises an audio interface and wherein said card reader connects to said computing device via a microphone port or headphone port.

20. The method of claim 15 wherein said payment card comprises a magnetic stripe for storing said payment card data and wherein said reader head comprises a magnetic head.

21. The method of claim 15 wherein said payment card comprises a contact-type smart card and said contact-type smart card comprises an electronic circuit for storing said payment card data and wherein said reader head comprises an electrical contact circuit head.

22. The method of claim 15 wherein said payment card comprises a contactless smart card and said contactless smart card comprises an electronic circuit for storing said payment card data and wherein said reader head comprises a contactless near-field electromagnetic circuit head.

23. The method of claim 15 wherein said card swipe application prompts a user to swipe the payment card in said card reader and wherein the card reader checks for an error in said payment card data and verifies absence of an error in said payment card data.

24. The method of claim 16, wherein said encryption application encrypts said payment card data with a second encryption key.

25. The method of claim 24 wherein said second encryption key is derived from the first encryption key.

26. The method of claim 15 further comprising providing a plurality of card readers and wherein said payment server comprises a database that stores all of said card readers IDs and their corresponding encryption keys and wherein the payment server uses the reader ID of a card reader to find the corresponding encryption keys and uses the encryption keys to decrypt the encrypted payment card data and to generate a local payment server TAB.

27. The method of claim 26 wherein said payment server authenticates the transaction data by comparing the TAB forwarded by the checkout application with the generated local payment server TAB.
